(19) United States
(12) Patent Application Publication
(10) Pub. No.: US 2026/0109644 A1
(43) Pub. Date: Apr. 23, 2026

(54) Comprehensive utilization method for iron separation tailings from magnetizing-roasted red mud

(71) Applicant: ZHENGZHOU NON-FERROUS METALS RESEARCH INSTITUTE CO.LTD OF CHALCO, Zhengzhou (CN)

(72) Inventors: Wuxing DU, Zhengzhou (CN); Jianqiang ZHANG, Zhengzhou (CN); Junwei MA, Zhengzhou (CN); Guoliang WU, Zhengzhou (CN); Xin GUO, Zhengzhou (CN); Zhaobin WEI, Zhengzhou (CN); Zhongyuan LIU, Zhengzhou (CN); Zhanyun ZHANG, Zhengzhou (CN); Zhiyong ZHANG, Zhengzhou (CN); Le ZHANG, Zhengzhou (CN); Ke XU, Zhengzhou (CN); Meng ZHANG, Zhengzhou (CN); Shasha LI, Zhengzhou (CN); Jie YAO, Zhengzhou (CN)

(73) Assignee: ZHENGZHOU NON-FERROUS METALS RESEARCH INSTITUTE CO.LTD OF CHALCO, Zhengzhou (CN)

(21) Appl. No.: 19/428,184

(22) Filed: Dec. 20, 2025

Related U.S. Application Data
(63) Continuation of application No. PCT/CN2024/105198, filed on Jul. 12, 2024.

(30) Foreign Application Priority Data
Jul. 12, 2023 (CN) 202310853290.3

(51) Int. Cl. C04B 7/42; B03B 7/00; B03C 1/30; C04B 7/43; C04B 7/52; C04B 11/28; C04B 22/04; C04B 28/14; C04B 111/00

(52) U.S. Cl. CPC C04B 7/421; B03B 7/00; B03C 1/30; C04B 7/434; C04B 7/52; C04B 11/28; C04B 22/04; C04B 28/142; B03C 2201/22; C04B 2111/00215

(57) ABSTRACT

A comprehensive utilization method for iron separation tailings from magnetizing-roasted red mud includes the following steps: performing a wet magnetic separation for tailing discarding on iron separation tailings from magnetizing-roasted red mud, to obtain a rough concentrate and non-magnetic minerals; performing a purification by gravity separation on the rough concentrate to obtain a wet iron concentrate and light minerals; dehydrating the wet iron concentrate to obtain an iron concentrate; combining, and then dehydrating, drying, and disintegrating the non-magnetic minerals and the light minerals, to obtain iron extraction tailings; uniformly mixing the iron extraction tailings, and crushed, ground, and dried limestone, clay, and quartz sand separation tailings according to a predetermined ratio to obtain a cement raw meal; pressing, and then calcining and quenching the cement raw meal to obtain a cement clinker; and mixing the cement clinker and a gypsum followed by a dry grinding to obtain a silicate cement.

### CROSS-REFERENCE TO RELATED APPLICATIONS

This is a continuation of International Application No. PCT/CN2024/105198, filed on Jul. 12, 2024, which claims priority to Chinese Patent Application No. 202310853290.3, filed on Jul. 12, 2023. The disclosures of the above-referenced applications are hereby incorporated by reference in their entirety.

### TECHNICAL FIELD

The disclosure relates to the field of the aluminum industry, and in particular, to red mud.

### BACKGROUND

With the continuous increase in alumina production in China, an annual discharge volume and stockpiling volume of red mud are also increasing. By the end of 2021, a total stockpiling volume of red mud in China was about 1.6 billion tons, occupying an area of more than 8,667 hectares. However, an average comprehensive utilization rate for red mud was less than 6%, which is still far from a target value of over 60% required by the National Development and Reform Commission of China. Recovering iron minerals from red mud can not only provide raw materials for iron and steel enterprises to reduce China's external dependence on iron ore but also alleviate an environmental pressure on alumina enterprises. Conventional magnetic separation technology cannot achieve an effective recovery of iron minerals from high-iron red mud. A magnetizing roasting-iron separation process for red mud is an effective way to achieve resource recovery and utilization of iron minerals in red mud. After the magnetizing roasting-iron separation process is performed on the red mud, an iron concentrate with a high content of total iron (Tfe) can be obtained, but iron separation tailings from magnetizing-roasted red mud is also produced. The iron separation tailings is difficult to be utilized due to a series of reasons including its fine particle size, low content of γ-2CaO·SiO₂, and relatively low content of iron.

### SUMMARY

By utilizing one or more embodiments of the disclosure, a technical problem that iron separation tailings from magnetizing-roasted red mud are difficult to be utilized is solved.

According to some embodiments of the disclosure, A comprehensive utilization method for iron separation tailings from magnetizing-roasted red mud is provided. The comprehensive utilization method may include the following steps: performing a wet magnetic separation for tailing discarding on iron separation tailings from magnetizing-roasted red mud, to obtain a rough concentrate and non-magnetic minerals; performing a purification by gravity separation on the rough concentrate to obtain a wet iron concentrate and light minerals; dehydrating the wet iron concentrate to obtain an iron concentrate; combining, and then dehydrating, drying, and disintegrating the non-magnetic minerals and the light minerals, to obtain iron extraction tailings; uniformly mixing the iron extraction tailings, and crushed, ground, and dried limestone, clay, and quartz sand separation tailings according to a predetermined ratio to obtain a cement raw meal; pressing, and then calcining and quenching the cement raw meal to obtain a cement clinker; and mixing the cement clinker and a gypsum followed by a dry grinding to obtain a silicate cement.

### BRIEF DESCRIPTION OF DRAWINGS

The drawings, which are incorporated in and constitute a part of this specification, illustrate embodiments consistent with the disclosure and, together with the description, serve to explain the principles of the disclosure.

To illustrate the embodiments of the disclosure or the technical solutions in the related art more clearly, a brief introduction is made below to the drawings required for describing the embodiments or the related art. Obviously, for a person skilled in the art, other drawings may be obtained based on these drawings without making any creative efforts.

FIG. 1 shows a schematic flow diagram of a comprehensive utilization method for iron separation tailings from magnetizing-roasted red mud according to some embodiments of the disclosure.

### DETAILED DESCRIPTION

To make the purposes, technical solutions, and advantages of the embodiments of the disclosure clearer, the technical solutions in the embodiments of the disclosure will be clearly and completely described below in conjunction with the drawings in the embodiments of the disclosure. Obviously, the described embodiments are only some embodiments of the disclosure, rather than all embodiments. Based on the embodiments in the disclosure, all other embodiments obtained by a person skilled in the art without creative efforts shall fall within the protection scope of the disclosure.

Unless otherwise specified, the terms used herein should be understood as having the meanings commonly used in the art. Therefore, unless otherwise defined, all technical and scientific terms used herein have the same meanings as commonly understood by a person skilled in the art to which this disclosure belongs. In case of conflict, this description shall prevail.

Unless otherwise specified, various raw materials, reagents, instruments, and equipment used in the disclosure can be obtained by market purchase or can be prepared by existing methods.

Existing iron separation tailings from magnetizing-roasted red mud present a technical problem of being difficult to be utilized.

To solve the above technical problem, a general idea disclosed in the comprehensive utilization method for the iron separation tailings from magnetizing-roasted red mud according to some embodiments of the disclosure is as follows.

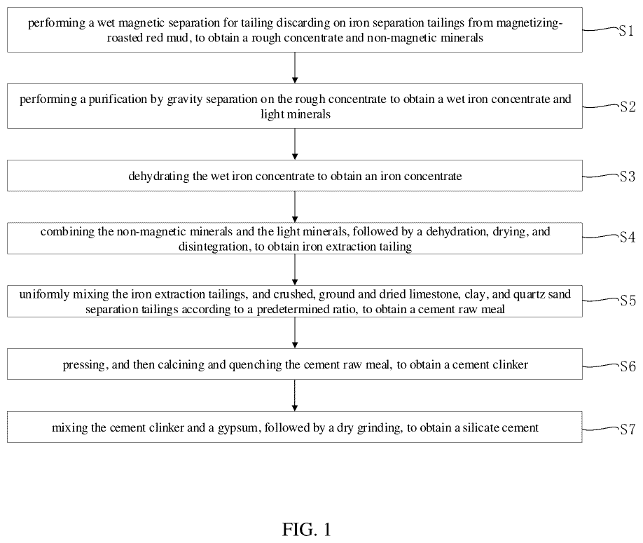

As shown in FIG. 1, the comprehensive utilization method for the iron separation tailings from magnetizing-roasted red mud according to some embodiments of the disclosure includes the following steps.
S1: performing a wet magnetic separation for tailing discarding on iron separation tailings from magnetizing-roasted red mud, to obtain a rough concentrate and non-magnetic minerals;
S2: performing a purification by gravity separation on the rough concentrate to obtain a wet iron concentrate and light minerals;
S3: dehydrating the wet iron concentrate to obtain an iron concentrate;
S4: combining the non-magnetic minerals and the light minerals, followed by a dehydration, drying, and disintegration, to obtain iron extraction tailings;
S5: uniformly mixing the iron extraction tailings, and crushed, ground and dried limestone, clay, and quartz sand separation tailings according to a predetermined ratio, to obtain a cement raw meal;
S6: pressing, and then calcining and quenching the cement raw meal, to obtain a cement clinker; and
S7: mixing the cement clinker and a gypsum, followed by a dry grinding, to obtain a silicate cement.

A person skilled in the art may understand that the wet magnetic separation for tailing discarding process is a conventional technical means in the art. The rough concentrate selected by wet magnetic separation for tailing discarding is magnetic and enriched with iron elements.

In some embodiments of the disclosure, the purification by gravity separation is a way of purification that a difference in density and particle size is utilized between the wet iron concentrate and the light minerals. By the purification by gravity separation, the wet iron concentrate with a higher density can be selected, and the wet iron concentrate can be dehydrated to obtain the iron concentrate.

In some embodiments of the disclosure, main components of the iron extraction tailings are iron oxide, silicon dioxide, calcium oxide, and the like, and the iron extraction tailings also contain a small amount of residual aluminum oxide, making them suitable for cement preparation.

In some embodiments of the disclosure, in the step of uniformly mixing the iron extraction tailings, and crushed, ground and dried limestone, clay, and quartz sand separation tailings according to a predetermined ratio to obtain a cement raw meal, “crushed, ground and dried” refers to an abbreviation of crushing, grinding, and drying. That is, the limestone, clay, and quartz sand separation tailings are respectively crushed, ground, and dried and then mixed according to the predetermined ratio, or the limestone, clay, and quartz sand separation tailings are mixed according to the predetermined ratio and then crushed, ground, and dried.

In some embodiments of the disclosure, by ways such as a wet magnetic separation for tailing discarding, a purification by gravity separation, an iron concentrate can be extracted from iron separation tailings from magnetizing-roasted red mud, for iron and steel smelting; the obtained iron extraction tailings can be mixed with a limestone, clay, and quartz sand separation tailings for preparing a silicate cement. By utilizing the comprehensive utilization method for the iron separation tailings from magnetizing-roasted red mud according to the disclosure to process the iron separation tailings from magnetizing-roasted red mud, iron resources, silicon resources, and calcium resources in the iron separation tailings from magnetizing-roasted red mud can be fully utilized, thereby achieving an effective utilization of the iron separation tailings from magnetizing-roasted red mud.

In some embodiments of the disclosure, based on a mass percentage of the iron separation tailings from magnetizing-roasted red mud, in the iron separation tailings from magnetizing-roasted red mud, a content of Fe₂O₃ is not higher than 58%, a content of SiO₂ is not higher than 15%, a content of CaO is not higher than 2.5%, and a content of Na₂O is not higher than 1.0%.

In some embodiments of the disclosure, the iron separation tailings from magnetizing-roasted red mud may be selected from iron separation tailings from magnetizing-roasted red mud produced by alumina plants in China during alumina production using the Bayer process.

In some embodiments of the disclosure, by controlling a content of Fe₂O₃ in the iron separation tailings from magnetizing-roasted red mud to be not higher than 58%, a content of SiO₂ to be not higher than 15%, a content of CaO to be not higher than 2.5%, and a content of Na₂O to be not higher than 1.0%, it can be ensured that the iron separation tailings from magnetizing-roasted red mud contain sufficient iron elements, and contents of elements required for a silicate cement, thereby ensuring that a high-grade iron concentrate can be obtained, and also ensuring that the obtained iron extraction tailings can be proportioned with other raw materials to obtain a silicate cement meeting strength requirements.

In some embodiments of the disclosure, in the iron separation tailings from magnetizing-roasted red mud, a proportion of particles with a particle size of less than 0.038 mm is 50% to 60%.

In some embodiments of the disclosure, a magnetic field intensity of the wet magnetic separation for tailing discarding is 0.3 T to 0.6 T; and/or, a pulsation frequency of the wet magnetic separation for tailing discarding is 220 times/min to 290 times/min.

By controlling the magnetic field intensity of the wet magnetic separation for tailing discarding to be 0.3 T to 0.6 T, it is advantageous to obtain a rough concentrate with better quality and a higher recovery rate, thereby minimizing an impurity content in the rough concentrate as much as possible. If a value of the magnetic field intensity is too large, it will cause an iron content of the rough concentrate to decrease; if a value of the magnetic field intensity is too small, it will reduce an iron recovery rate of the iron separation tailings from magnetizing-roasted red mud and cause iron minerals in the iron separation tailings from magnetizing-roasted red mud to be lost into the non-magnetic minerals.

By controlling the pulsation frequency of the wet magnetic separation for tailing discarding to be 220 times/min to 290 times/min, it is advantageous to obtain a rough concentrate with better quality and a higher recovery rate, and to minimize the impurity content in the rough concentrate as much as possible. If a value of the pulsation frequency is too large, it will cause iron in the rough concentrate to be lost into the non-magnetic minerals; if a value of the pulsation frequency is too small, it will cause severe inclusion of non-magnetic minerals in the rough concentrate, resulting in a decrease in the iron content of the rough concentrate, thereby affecting an effect of the subsequent purification by gravity separation.

In some embodiments of the disclosure, the purification by gravity separation adopts at least two processes connected in series which are selected from the group consisting of a purification by gravity separation process using a shaking table, a centrifugal purification by gravity separation process, and a purification by gravity separation process using a spiral chute; and/or, the number of times of the purification by gravity separation process is 2 to 3 times.

The manner of purification by gravity separation is required to be controlled because a single purification by gravity separation process is not easy to obtain a high-quality iron concentrate. Adopting a method of connecting two or more purification by gravity separation processes in series can utilize advantages of the purification by gravity separation process using a shaking table, the centrifugal purification by gravity separation process, and the purification by gravity separation process using a spiral chute to overcome problems existing in a single purification by gravity separation process, thereby obtaining a wet iron concentrate with considerable yield and high iron content. A number of times of the purification by gravity separation process is controlled to be 2 to 3 because a content of Fe₂O₃ of the iron concentrate can be increased as much as possible through repeated purification by gravity separation processes, while contents of impurity elements such as SiO₂, Al₂O₃, and Na₂O can be fully reduced, thereby obtaining a high-quality wet iron concentrate that can be used as a raw material for steel production. However, the number of times of the purification by gravity separation processes cannot be increased indefinitely. If the number of times of the purification by gravity separation process is too large, a cost of purification by gravity separation is relatively high, which does not conform to an original intention of comprehensive utilization of the iron separation tailings from magnetizing-roasted red mud.

In some embodiments of the disclosure, in the iron extraction tailings, a proportion of particles with a particle size of less than 0.074 mm is more than 88%; and/or, a content of water in the iron extraction tailings is not higher than 2%.

To obtain raw materials suitable for producing the silicate cement, the proportion of particles with a particle size of less than 0.074 mm in the iron extraction tailings is controlled to be more than 88%, and the content of water in the iron extraction tailings is controlled to be not higher than 2%. If the content of water in the iron extraction tailings is too high, it will not facilitate the disintegration and dispersion of the iron extraction tailings. If the content of water in the iron extraction tailings is too low, it will lead to excessive energy consumption for drying the iron extraction tailings, thereby affecting an economy of the process. A fineness of the iron extraction tailings is controlled so that the iron extraction tailings can meet requirements for producing the silicate cement, to achieve a full-volume utilization of the iron separation tailings from magnetizing-roasted red mud, thereby improving a utilization rate of red mud.

In some embodiments of the disclosure, based on a mass percentage of the cement raw meal, the predetermined ratio is: 4% to 12% of iron extraction tailings, 60% to 75% of limestone, 15% to 25% of clay, and 4% to 8% of quartz sand separation tailings.

In some embodiments of the disclosure, a proportion of each raw material in the cement raw meal can be calculated based on an objective of achieving a lime saturation factor (KH) of 0.84 to 0.89, a silica modulus (SM) of 1.8 to 2.4, and an iron modulus (IM) of 1.0 to 1.8 for the cement clinker, and in combination with a chemical composition of each raw material.

KH (Lime Saturation Factor) is a lime saturation coefficient of cement clinker, representing a degree to which SiO₂ in the cement clinker is saturated by calcium oxide to form tricalcium silicate.

SM (Silica Modulus) is a silica modulus of cement clinker, representing a ratio of a percentage content of SiO₂ to percentage contents of Al₂O₃ and Fe₂O₃ in the cement clinker, and also representing a ratio of silicate minerals to flux minerals in the cement clinker.

IM (Iron Modulus) is an iron modulus of cement clinker, representing a ratio of a percentage content of Al₂O₃ to a percentage content of Fe₂O₃ in the cement clinker.

By controlling KH of the cement clinker to be 0.84 to 0.89, SM to be 1.8 to 2.4, and IM to be 1.0 to 1.8, the cement clinker can have good mechanical properties. Based on values of KH, SM, and IM of the cement clinker, and in combination with chemical compositions of the iron extraction tailings, limestone, clay, and quartz sand separation tailings, the predetermined ratio of the iron extraction tailings, limestone, clay, and quartz sand separation tailings in the cement raw meal can be calculated. A chemical composition of the cement clinker can also be calculated from the values of KH, SM, and IM of the cement clinker, to ensure that contents of minerals such as C₃S, C₂S, C₃A, and C₄AF in the cement clinker meet expected requirements, thereby ensuring mechanical properties of the silicate cement clinker. Furthermore, the iron separation tailings from magnetizing-roasted red mud can be utilized to a great extent, to provide technical support for comprehensive utilization of the iron separation tailings from magnetizing-roasted red mud.

In some embodiments of the disclosure, in the step of pressing, and then calcining and quenching the cement raw meal to obtain the cement clinker, a pressure for the pressing ranges from 3 MPa to 6 MPa.

Controlling the pressure for pressing the cement raw meal to be 3 MPa to 6 MPa can ensure that the cement raw meal can be pressed into shape. If a value of the pressing pressure is too small, the cement raw meal cannot be pressed into shape, and a subsequent calcination operation cannot be performed. If a value of the pressing pressure is too large, the cement raw meal will be too compact after molding, leading to incomplete calcination of the subsequently produced cement raw meal, thereby affecting mechanical properties of the obtained cement clinker.

In some embodiments of the disclosure, the cement raw meal can be pressed into a cylinder, a diameter of the cylinder can be 50 mm, and a height thereof can be 40 mm to 60 mm.

By controlling the diameter of the cylinder pressed from the cement raw meal to be 50 mm and the height thereof to be 40 mm to 60 mm, a volume of the cylinder pressed from the cement raw meal can be controlled, making the cylinder pressed from the cement raw meal convenient for calcination. If the volume of the cylinder pressed from the cement raw meal is too large, it will adversely affect a calcination reaction of the subsequent cement raw meal, thereby affecting a performance of the subsequently produced silicate cement. If the volume of the cylinder pressed from the cement raw meal is too small, it will affect production efficiency.

In some embodiments of the disclosure, in the step of pressing and then calcining and quenching the cement raw meal to obtain the cement clinker, a temperature for the calcining ranges from 1350° C. to 1450° C., and a time for the calcining ranges from 70 min to 100 min.

By controlling a calcination temperature of the cylinder pressed from the cement raw meal to be 1350° C. to 1450° C. and a calcination time of the cylinder pressed from the cement raw meal to be 70 min to 100 min, it can be ensured that chemical components in the cylinder pressed from the cement raw meal are calcined into a hydraulic cementitious substance mainly composed of calcium silicate. If a value of the calcination temperature is too small and/or a value of the calcination time is too small, the cement raw meal will not be completely calcined, affecting a mineral composition in the cement clinker and in turn affecting a performance of the silicate cement. If a value of the calcination temperature is too large and/or a value of the calcination time is too large, it will be unfavorable for formation of minerals such as C₃S, C₂S, C₃A, and C₄AF in the cement clinker, and an excessively high calcination temperature and an excessively long calcination time will also increase additional energy consumption, reducing an economy.

In some embodiments of the disclosure, a specific surface area of the silicate cement is 400 m²/kg, wherein a proportion of particles with a particle size of less than 0.045 mm is 93% to 95%. In some embodiments of the disclosure, by controlling a specific surface area of the silicate cement to be 400 m²/kg, and by controlling a grinding fineness so that a proportion of particles with a particle size of less than 0.045 mm in the silicate cement is 93% to 95%, mechanical properties of the silicate cement can be ensured. If the specific surface area and a value of particle size of the silicate cement are too small, it will affect a strength of the silicate cement, thereby affecting sales of the cement. If the specific surface area and values of particle size of the silicate cement are too large, it will lead to high early strength but insufficient later development of the silicate cement, and will also increase production energy consumption of the silicate cement, reducing market competitiveness of the product.

In some embodiments of the disclosure, the specific surface area of the silicate cement is 380 m²/kg to 400 m²/kg, wherein a proportion of particles with a particle size of less than 0.045 mm is 90% to 95%.

By controlling the specific surface area of the silicate cement to be 380 m²/kg to 400 m²/kg, and by controlling the grinding fineness so that a proportion of particles with a particle size of less than 0.045 mm in the silicate cement is 90% to 95%, mechanical properties of the silicate cement can be ensured. If the specific surface area and particle size of the silicate cement are too small, it will affect a strength of the silicate cement, thereby affecting sales of the cement. If the specific surface area and particle size of the silicate cement are too large, it will lead to high early strength but insufficient later development of the silicate cement, and will also increase production energy consumption of the silicate cement, reducing market competitiveness of the product.

The disclosure is further elaborated below in conjunction with specific examples. It should be understood that these examples are only used to illustrate the disclosure but are not used to limit the scope of the disclosure. The experimental methods without specified specific conditions in the following examples are usually measured in accordance with Chinese national standards. If no corresponding Chinese national standard exists, the experimental methods are proceeded according to general international standards, conventional conditions, or conditions recommended by the manufacturer.

### Example 1

Iron separation tailings from magnetizing-roasted red mud used in this example were iron separation tailings from magnetizing-roasted red mud obtained during alumina production using the Bayer process at an aluminum plant in Guangxi province of China. The iron separation tailings from magnetizing-roasted red mud, by weight percentage, contains 18.84% of Al₂O₃, 10.64% of SiO₂, 57.66% of Fe₂O₃, and 1.25% of CaO; and 52.87% of its mass consisted of particles finer than 0.038 mm (i.e., a proportion of particles with a size less than 0.038 mm was 52.87%, the same meaning applies hereinafter). In the iron separation tailings from magnetizing-roasted red mud in this example, valuable minerals were magnetite and limonite; and gangue minerals were mainly anatase, rutile, sodium aluminosilicate, quartz, and the like. The comprehensive utilization method for the iron separation tailings from magnetizing-roasted red mud disclosed in this example includes the following steps.

First, the iron separation tailings from magnetizing-roasted red mud was subjected to a processing of wet magnetic separation with tailing discarding including one stage of roughing (during which a magnetic field intensity was 0.3 T; a pulsation frequency was 230 times/min) and one stage of scavenging (during which a magnetic field intensity was 0.35 T; a pulsation frequency was 250 times/min), to obtain a rough concentrate and non-magnetic minerals. The rough concentrate was subjected to a processing of purification by gravity separation including one stage of roughing (using a spiral chute for gravity separation process) and two stages of cleaning (the first cleaning stage using a fine sand shaking table for gravity separation process; and the second cleaning stage using a slime shaking table for gravity separation process). After the purification by gravity separation, a wet iron concentrate and light minerals were obtained. The wet iron concentrate was dehydrated to obtain an iron concentrate. The non-magnetic minerals and the light minerals were combined to obtain wet tailings. The wet tailings were then dehydrated, dried, and disintegrated to obtain an iron extraction tailings. In this example, for the iron concentrate, a yield was 12.41%, a content of Fe₂O₃ was 80.42%, and the iron concentrate could be sold as a raw material for iron and steel; for the iron extraction tailings, a yield was 87.59%, a content of Fe₂O₃ was 54.44%, and a content of water was 1.21%, and a content of particles thereof finer than 0.074 mm was 89.12%. The cement clinker was preset with KH of 0.86, SM of 2.2, and IM of 1.2. Based on main chemical compositions of each raw material for preparing the cement raw meal, referring to Table 1, a calculated predetermined ratio for the cement raw meal was: 4.04% of iron extraction tailings, 74.02% of limestone, 17.82% of clay, and 4.12% of quartz sand separation tailings. Therefore, the cement raw meal can be prepared by uniformly mixing the iron extraction tailings, the limestone, the clay, and the quartz sand separation tailings according to the predetermined ratio. The cement raw meal was pressed under a pressure of 3 MPa into a cylinder with a diameter of 50 mm and a height of 60 mm. The cylinder formed by pressing the cement raw meal was calcined at 1350° C. for 80 min, then taken out and quenched to obtain a cement clinker. The cement clinker was mixed with a gypsum in a ratio of 92:8 and then dry-ground. A specific surface area of ground materials was controlled to be 390 m²/kg and a content of particles finer than 0.045 mm was controlled to be 94%, to finally obtain a silicate cement.

The prepared silicate cement was taken. A setting time of the silicate cement was measured and determined according to the Chinese National Standard GB/T 1346-2011 Test methods for water requirement of normal consistency, setting time and soundness of the portland cement; a compressive strength and a flexural strength of the silicate cement were measured and determined according to the Chinese National Standard GB/T 17671-2021 Test method of cement mortar strength (ISO method), i.e., the silicate cement, standard sand, and water with a ratio of 450:1350:225 were made into a prism with dimensions of 40 mm×40 mm×160 mm. The prism was demolded after 1 day and cured. The compressive strength and the flexural strength of the prism at 3 days and 28 days were measured, respectively, to analyze a performance of the silicate cement. Test results of indicators of iron extraction and indicators of the silicate cement were shown in Table 2.

TABLE 1
Main chemical composition (%) of raw materials for preparation of cement in Example 1

| Item | CaO | SiO₂ | Al₂O₃ | Fe₂O₃ | MgO | SO₃ | K₂O | Na₂O | Loss | Total |
|---|---|---|---|---|---|---|---|---|---|---|
| Limestone | 52.79 | 1.58 | 0.52 | 0.11 | 0.13 | 0.01 | 0 | 1.25 | 42.22 | 98.61 |
| Clay | 12.64 | 49.55 | 12.94 | 3.24 | 0.15 | 2.31 | 0.91 | 4.01 | 13.88 | 99.63 |
| Quartz sand | 0.11 | 90.45 | 0.12 | 0.27 | 0.13 | 0 | 0.22 | 0.24 | 5.74 | 97.28 |
| separation tailings | | | | | | | | | | |
| Iron extraction | 2.78 | 13.75 | 18.84 | 54.44 | 0.24 | 0.00 | 0.19 | 0.99 | 1.95 | 93.18 |
| tailings | | | | | | | | | | |

TABLE 2
Test results of indicators of iron extraction and
indicators of the silicate cement for Example 1

| | | | Test results of silicate cement | | | | | |
|---|---|---|---|---|---|---|---|---|
| | | | prepared from iron extraction tailings | | | | | |
| Test results of iron extraction/% | | | Setting time/min | | Compressive | | Flexural | |
| | | Content | Initial | Final | strength/MPa | | strength/MPa | |
| Name | Yield | of Fe₂O₃ | setting | setting | 3 d | 28 d | 3 d | 28 d |
| Iron concentrate | 12.41 | 80.42 | 48 | 112 | 28.6 | 60.3 | 4.8 | 8.5 |
| Iron extraction | 87.59 | 54.44 | | | | | | |
| tailings | | | | | | | | |
| Total | 100.00 | 57.66 | | | | | | |

As can be seen from the test results in Table 2, after the iron separation tailings from magnetizing-roasted red mud disclosed in this example were subjected to a processing of an iron extraction process of combined magnetic separation-gravity separation, an iron concentrate with a yield of 12.41% and a content of Fe₂O₃ of 80.42%, and iron extraction tailings with a yield of 87.59% and a content of Fe₂O₃ of 54.44% were obtained. The silicate cement prepared from the iron extraction tailings has the compressive strengths of 28.6 Mpa and 60.3 Mpa at 3 days and 28 days, respectively, and the flexural strengths of 4.8 Mpa and 8.5 Mpa at 3 days and 28 days, respectively. The initial setting time and the final setting time of the silicate cement were 48 min and 112 min, respectively. According to the comprehensive evaluation of indicators of the setting time, the compressive strength, and the flexural strength, this silicate cement meets requirements for Grade 52.5 as specified in Chinese National Standard GB 175-2020 Common portland cement. Thus, a comprehensive utilization of the iron separation tailings from magnetizing-roasted red mud was achieved.

### Example 2

Iron separation tailings from magnetizing-roasted red mud used in this example were iron separation tailings from magnetizing-roasted red mud obtained during alumina production using the Bayer process at an aluminum plant in Guangxi province of China. The iron separation tailings from magnetizing-roasted red mud, by weight percentage, contains 16.95% of Al₂O₃, 14.23% of SiO₂, 53.66% of Fe₂O₃, and 2.01% of CaO; and a content of fineness of-0.038 mm of the iron separation tailings from magnetizing-roasted red mud was 54.66%. In the iron separation tailings from magnetizing-roasted red mud in this example, valuable minerals were mainly magnetite and limonite; and gangue minerals were mainly anatase, rutile, sodium aluminosilicate, quartz, and the like. The comprehensive utilization method for the iron separation tailings from magnetizing-roasted red mud disclosed in this example includes the following steps.

First, the iron separation tailings from magnetizing-roasted red mud were subjected to a processing of wet magnetic separation with tailing discarding including one stage of roughing (during which a magnetic field intensity was 0.3 T; a pulsation frequency was 220 times/min) and one stage of scavenging (during which a magnetic field intensity was 0.4 T; a pulsation frequency was 260 times/min), to obtain a rough concentrate and non-magnetic minerals. The rough concentrate was subjected to a processing of purification by gravity separation including one stage of roughing (using a slime shaking table for gravity separation process) and one stage of cleaning (using a centrifugal gravity separation process). After the purification by gravity separation, a wet iron concentrate and light minerals were obtained. The wet iron concentrate was dehydrated to obtain an iron concentrate. The non-magnetic minerals and the light minerals were combined to obtain wet tailings. The wet tailings were then dehydrated, dried, and disintegrated to obtain an iron extraction tailings. In this example, for the iron concentrate, a yield was 13.62%, a content of Fe₂O₃ was 81.85%, and the iron concentrate could be sold as a raw material for iron and steel; for the iron extraction tailings, a yield was 86.38%, a content of Fe₂O₃ was 49.22%, and a content of water was 1.79%, and a content of fineness of-0.074 mm was 90.55%. The cement clinker was preset with KH of 0.87, SM of 2.11, and IM of 1.2. Based on main chemical compositions of each raw material for preparing the cement raw meal, referring to Table 3, a calculated predetermined ratio for the cement raw meal was: 5.41% of iron extraction tailings, 73.79% of limestone, 16.53% of clay, and 4.27% of quartz sand separation tailings. Therefore, the cement raw meal can be prepared by uniformly mixing the iron extraction tailings, the limestone, the clay, and the quartz sand separation tailings according to the predetermined ratio. The cement raw meal was pressed under a pressure of 4 MPa into a cylinder with a diameter of 50 mm and a height of 50 mm. The cylinder formed by pressing the cement raw meal was calcined at 1400° C. for 90 min, then taken out and quenched to obtain a cement clinker. The cement clinker was mixed with a gypsum in a ratio of 91:9 and then dry-ground. A specific surface area of ground materials was controlled to be 380 m²/kg and a content of fineness of-0.045 mm was controlled to be 93%, to finally obtain a silicate cement.

The prepared silicate cement was taken. A setting time of the silicate cement was measured and determined according to the Chinese National Standard GB/T 1346-2011 Test methods for water requirement of normal consistency, setting time and soundness of the portland cement; a compressive strength and a flexural strength of the silicate cement were measured and determined according to the Chinese National Standard GB/T 17671-2021 Test method of cement mortar strength (ISO method), i.e., the silicate cement, a standard sand, and a water with a ratio of 450:1350:225 were made into a prism with dimensions of 40 mm×40 mm×160 mm. The prism was demolded after 1 day and cured. The compressive strength and the flexural strength of the prism at 3 days and 28 days were measured, respectively, to analyze a performance of the silicate cement. Test results of indicators of iron extraction and indicators of the silicate cement were shown in Table 4.

TABLE 3
Main chemical composition (%) of raw materials for cement preparation in Example 2

| Item | CaO | SiO₂ | Al₂O₃ | Fe₂O₃ | MgO | SO₃ | K₂O | Na₂O | Loss | Total |
|---|---|---|---|---|---|---|---|---|---|---|
| Limestone | 52.79 | 1.58 | 0.52 | 0.11 | 0.13 | 0.01 | 0 | 1.25 | 42.22 | 98.61 |
| Clay | 12.64 | 49.55 | 12.94 | 3.24 | 0.15 | 2.31 | 0.91 | 4.01 | 13.88 | 99.63 |
| Quartz sand | 0.11 | 90.45 | 0.12 | 0.27 | 0.13 | 0 | 0.22 | 0.24 | 5.74 | 97.28 |
| separation tailings | | | | | | | | | | |
| Iron extraction | 2.09 | 15.23 | 17.11 | 49.22 | 0.36 | 0 | 0.12 | 0.77 | 3.01 | 87.92 |
| tailings | | | | | | | | | | |

TABLE 4
Test results of indicators of iron extraction and
indicators of the silicate cement for Example 2

| | | | Test results of silicate cement | | | | | |
|---|---|---|---|---|---|---|---|---|
| | | | prepared from iron extraction tailings | | | | | |
| Test results of iron extraction/% | | | Setting time/min | | Compressive | | Flexural | |
| | | Content | Initial | Final | strength/MPa | | strength/MPa | |
| Name | Yield | of Fe₂O₃ | setting | setting | 3 d | 28 d | 3 d | 28 d |
| Iron concentrate | 13.62 | 81.85 | 61 | 133 | 27.8 | 59.5 | 4.8 | 8.6 |
| Iron extraction | 86.38 | 49.22 | | | | | | |
| tailings | | | | | | | | |
| Total | 100.00 | 53.66 | | | | | | |

As can be seen from the test results in Table 4, after the iron separation tailings from magnetizing-roasted red mud disclosed in this example were subjected to a processing of an iron extraction process of combined magnetic separation-gravity separation, an iron concentrate with a yield of 13.62% and a content of Fe₂O₃ of 81.85%, and iron extraction tailings with a yield of 86.38% and a content of Fe₂O₃ of 49.22% were obtained. The silicate cement prepared from the iron extraction tailings has the compressive strengths of 27.8 MPa and 59.5 MPa at 3 days and 28 days, respectively, and the flexural strengths of 4.8 MPa and 8.6 MPa at 3 days and 28 days, respectively. The initial setting time and the final setting time of the silicate cement were 61 min and 133 min, respectively. According to the comprehensive evaluation of indicators of the setting time, compressive strength, and flexural strength, this silicate cement meets requirements for Grade 52.5 as specified in Chinese National Standard GB175-2020 Common portland cement, and a comprehensive utilization of the iron separation tailings from magnetizing-roasted red mud was achieved.

### Example 3

Iron separation tailings from magnetizing-roasted red mud used in this example were iron separation tailings from magnetizing-roasted red mud obtained during alumina production using the Bayer process at an aluminum plant in ShanXi province of China. The iron separation tailings from magnetizing-roasted red mud, by weight percentage, contains 14.21% of Al₂O₃, 12.55% of SiO₂, 57.96% of Fe₂O₃, and 1.31% of CaO; and a content of fineness of-0.038 mm of the iron separation tailings from magnetizing-roasted red mud was 56.01%. In the iron separation tailings from magnetizing-roasted red mud in this example, valuable minerals were mainly hematite and magnetite; and gangue minerals were mainly alumogoethite, rutile, anatase, calcite, hydrogarnet, and sodium silicate residue, and the like. The comprehensive utilization method for the iron separation tailings from magnetizing-roasted red mud disclosed in this example includes the following steps.

First, the iron separation tailings from magnetizing-roasted red mud were subjected to a processing of wet magnetic separation with tailing discarding including one stage of roughing (during which a magnetic field intensity was 0.5 T; a pulsation frequency was 260 times/min) and one stage of scavenging (during which a magnetic field intensity was 0.6 T; a pulsation frequency was 290 times/min), to obtain a rough concentrate and non-magnetic minerals. The rough concentrate was subjected to a processing of purification by gravity separation including one stage of roughing (using a centrifugal gravity separation process) and one stage of cleaning (using a slime shaking table for gravity separation process). After the purification by gravity separation, a wet iron concentrate and light minerals were obtained. The wet iron concentrate was dehydrated to obtain an iron concentrate. The non-magnetic minerals and the light minerals were combined to obtain wet tailings. The wet tailings were then dehydrated, dried, and disintegrated to obtain an iron extraction tailings. In this example, for the iron concentrate, a yield was 18.62%, a content of Fe₂O₃ was 81.33%, and the iron concentrate could be sold as a raw material for iron and steel; for the iron extraction tailings, a yield was 81.38%, a content of Fe₂O₃ was 52.61%, and a content of water was 0.90%, and a content of fineness of-0.074 mm was 88.12%. The cement clinker was preset with KH of 0.86, SM of 2.1, and IM of 1.2. Based on main chemical compositions of each raw material for preparing the cement raw meal, referring to Table 5, a calculated predetermined ratio for the cement raw meal was: 5.11% of iron extraction tailings, 73.66% of limestone, 17.112% of clay, and 4.12% of quartz sand separation tailings. Therefore, the cement raw meal can be prepared by uniformly mixing the iron extraction tailings, the limestone, the clay, and the quartz sand separation tailings according to the predetermined ratio. The cement raw meal was pressed under a pressure of 5 MPa into a cylinder with a diameter of 50 mm and a height of 60 mm. The cylinder formed by pressing the cement raw meal was calcined at 1400° C. for 95 min, then taken out and quenched to obtain a cement clinker. The cement clinker was mixed with a gypsum in a ratio of 90:10 and then dry-ground. A specific surface area of ground materials was controlled to be 390 m²/kg and a content of fineness of-0.045 mm was controlled to be 93%, to finally obtain a silicate cement.

The prepared silicate cement was taken. A setting time of the silicate cement was measured and determined according to the Chinese National Standard GB/T 1346-2011 Test methods for water requirement of normal consistency, setting time and soundness of the portland cement; a compressive strength and a flexural strength of the silicate cement were measured and determined according to the Chinese National Standard GB/T 17671-2021 Test method of cement mortar strength (ISO method), i.e., the silicate cement, a standard sand, and a water with a ratio of 450:1350:225 were made into a prism with dimensions of 40 mm×40 mm×160 mm. The prism was demolded after 1 day and cured. The compressive strength and the flexural strength of the prism at 3 days and 28 days were measured, respectively, to analyze a performance of the silicate cement. Test results of indicators of iron extraction and indicators of the silicate cement were shown in Table 6.

TABLE 5
Main chemical composition (%) of raw materials for cement preparation in Example 3

| Item | CaO | SiO₂ | Al₂O₃ | Fe₂O₃ | MgO | SO₃ | K₂O | Na₂O | Loss | Total |
|---|---|---|---|---|---|---|---|---|---|---|
| Limestone | 52.79 | 1.58 | 0.52 | 0.11 | 0.13 | 0.01 | 0 | 1.25 | 42.22 | 98.61 |
| Clay | 12.64 | 49.55 | 12.94 | 3.24 | 0.15 | 2.31 | 0.91 | 4.01 | 13.88 | 99.63 |
| Quartz sand | 0.11 | 90.45 | 0.12 | 0.27 | 0.13 | 0 | 0.22 | 0.24 | 5.74 | 97.28 |
| separation tailings | | | | | | | | | | |
| Iron extraction | 1.55 | 14.56 | 17.11 | 52.61 | 0.51 | 0.03 | 0.52 | 0.77 | 3.46 | 91.32 |
| tailings | | | | | | | | | | |

TABLE 6
Test results of indicators of iron extraction and
indicators of the silicate cement for Example 3

| | | | Test results of silicate cement | | | | | |
|---|---|---|---|---|---|---|---|---|
| | | | prepared from iron extraction tailings | | | | | |
| Test results of iron extraction/% | | | Setting time/min | | Compressive | | Flexural | |
| | | Content | Initial | Final | strength/MPa | | strength/MPa | |
| Name | Yield | of Fe₂O₃ | setting | setting | 3 d | 28 d | 3 d | 28 d |
| Iron concentrate | 18.62 | 81.33 | 56 | 132 | 25.4 | 58.9 | 4.9 | 8.1 |
| Iron extraction | 81.38 | 52.61 | | | | | | |
| tailings | | | | | | | | |
| Total | 100.00 | 57.96 | | | | | | |

As can be seen from the test results in Table 6, after the iron separation tailings from magnetizing-roasted red mud disclosed in this example were subjected to a processing of an iron extraction process of combined magnetic separation-gravity separation, an iron concentrate with a yield of 18.62% and a content of Fe₂O₃ of 81.33%, and iron extraction tailings with a yield of 81.38% and a content of Fe₂O₃ of 52.61% were obtained. The silicate cement prepared from the iron extraction tailings has the compressive strengths of 25.4 MPa and 58.9 MPa at 3 days and 28 days, respectively, and the flexural strengths of 4.9 MPa and 8.1 MPa at 3 days and 28 days, respectively. The initial setting time and the final setting time of the silicate cement were 56 min and 132 min, respectively. According to the comprehensive evaluation of indicators of the setting time, the compressive strength, and the flexural strength, this silicate cement meets requirements for Grade 52.5 as specified in Chinese National Standard GB175-2020 Common portland cement. Thus, a comprehensive utilization of the iron separation tailings from magnetizing-roasted red mud was achieved.

### Example 4

Iron separation tailings from magnetizing-roasted red mud used in this example were iron separation tailings from magnetizing-roasted red mud obtained during alumina production using the Bayer process at an aluminum plant in Shan Dong province of China. The iron separation tailings from magnetizing-roasted red mud, by weight percentage, contains 17.77% of Al₂O₃, 13.66% of SiO₂, 52.04% of Fe₂O₃, and 1.01% of CaO; and a content of fineness of-0.038 mm of the iron separation tailings from magnetizing-roasted red mud was 50.82%. In the iron separation tailings from magnetizing-roasted red mud in this example, valuable minerals were hematite and limonite; and gangue minerals were mainly anatase, rutile, sodium aluminosilicate, sodium silicate residue, and quartz, and the like. The comprehensive utilization method for the iron separation tailings from magnetizing-roasted red mud disclosed in this example includes the following steps.

First, the iron separation tailings from magnetizing-roasted red mud were subjected to a processing of wet magnetic separation with tailing discarding including one stage of roughing (during which a magnetic field intensity was 0.4 T; a pulsation frequency was 230 times/min) and one stage of scavenging (during which a magnetic field intensity was 0.5 T; a pulsation frequency was 260 times/min), to obtain a rough concentrate and non-magnetic minerals. The rough concentrate was subjected to a processing of purification by gravity separation including one stage of roughing (using a spiral chute for gravity separation process) and one stage of cleaning (using a slime shaking table for gravity separation process). After the purification by gravity separation, a wet iron concentrate and light minerals were obtained. The non-magnetic minerals and the light minerals were combined to obtain wet tailings. The wet tailings were then dehydrated, dried, and disintegrated to obtain an iron extraction tailings. In this example, for the iron concentrate, a yield was 12.79%, a content of Fe₂O₃ was 80.25%, and the iron concentrate could be sold as a raw material for iron and steel; for the iron extraction tailings, a yield was 87.21%, a content of Fe₂O₃ was 47.90%, and a content of water was 1.09%, and a content of fineness of −0.074 mm was 90.11%.

The cement clinker was preset with KH of 0.87, SM of 2.3, and IM of 1.1. Based on main chemical compositions of each raw material for preparing the cement raw meal, referring to Table 7, a calculated predetermined ratio for the cement raw meal was: 5.01% of iron extraction tailings, 74.01% of limestone, 14.72% of clay, and 5.27% of quartz sand separation tailings. Therefore, the cement raw meal can be prepared by uniformly mixing the iron extraction tailings, the limestone, the clay, and the quartz sand separation tailings according to the predetermined ratio. The cement raw meal was pressed under a pressure of 5 MPa into a cylinder with a diameter of 50 mm and a height of 40 mm. The cylinder formed by pressing the cement raw meal was calcined at 1350° C. for 120 min, then taken out and quenched to obtain a cement clinker. The cement clinker was mixed with a gypsum in a ratio of 87:13 and then dry-ground. A specific surface area of ground materials was controlled to be 390 m²/kg and a content of fineness of-0.045 mm was controlled to be 94%, to finally obtain a silicate cement.

The prepared silicate cement was taken. A setting time of the silicate cement was measured and determined according to the Chinese National Standard GB/T 1346-2011 Test methods for water requirement of normal consistency, setting time and soundness of the portland cement; a compressive strength and a flexural strength of the silicate cement were measured and determined according to the Chinese National Standard GB/T 17671-2021 Test method of cement mortar strength (ISO method), i.e., the silicate cement, a standard sand, and a water with a ratio of 450:1350:225 were made into a prism with dimensions of 40 mm×40 mm×160 mm. The prism was demolded after 1 day and cured. The compressive strength and the flexural strength of the prism at 3 days and 28 days were measured, respectively, to analyze a performance of the silicate cement. Test results of indicators of iron extraction and indicators of the silicate cement were shown in Table 8.

TABLE 7
Main chemical composition (%) of raw materials for cement preparation in Example 4

| Item | CaO | SiO₂ | Al₂O₃ | Fe₂O₃ | MgO | SO₃ | K₂O | Na₂O | Loss | Total |
|---|---|---|---|---|---|---|---|---|---|---|
| Limestone | 52.79 | 1.58 | 0.52 | 0.11 | 0.13 | 0.01 | 0 | 1.25 | 42.22 | 98.61 |
| Clay | 12.64 | 49.55 | 12.94 | 3.24 | 0.15 | 2.31 | 0.91 | 4.01 | 13.88 | 99.63 |
| Quartz sand | 0.11 | 90.45 | 0.12 | 0.27 | 0.13 | 0 | 0.22 | 0.24 | 5.74 | 97.28 |
| separation tailings | | | | | | | | | | |
| Iron extraction | 2.25 | 16.11 | 17.11 | 47.90 | 0.52 | 0.00 | 0.31 | 0.52 | 3.21 | 87.73 |
| tailings | | | | | | | | | | |

TABLE 8
Test results of indicators of iron extraction and
indicators of the silicate cement for Example 4

| | | | Test results of silicate cement | | | | | |
|---|---|---|---|---|---|---|---|---|
| | | | prepared from iron extraction tailings | | | | | |
| Test results of iron extraction/% | | | Setting time/min | | Compressive | | Flexural | |
| | | Content | Initial | Final | strength/MPa | | strength/MPa | |
| Name | Yield | of Fe₂O₃ | setting | setting | 3 d | 28 d | 3 d | 28 d |
| Iron concentrate | 12.79 | 80.25 | 55 | 125 | 21.6 | 50.3 | 4.1 | 6.9 |
| Iron extraction | 87.21 | 47.90 | | | | | | |
| tailings | | | | | | | | |
| Total | 100.00 | 52.87 | | | | | | |

As can be seen from the test results in Table 8, after the iron separation tailings from magnetizing-roasted red mud disclosed in this example were subjected to a processing of an iron extraction process of combined magnetic separation-gravity separation, an iron concentrate with a yield of 12.79% and a content of Fe₂O₃ of 80.25%, and iron extraction tailings with a yield of 87.21% and a content of Fe₂O₃ of 47.90% were obtained. The silicate cement prepared from the iron extraction tailings has the compressive strengths of 21.60 MPa and 50.3 MPa at 3 days and 28 days, respectively, and the flexural strengths of 4.1 MPa and 6.9 MPa at 3 days and 28 days, respectively. The initial setting time and the final setting time of the silicate cement were 55 min and 125 min, respectively. According to the comprehensive evaluation of indicators of the setting time, the compressive strength, and the flexural strength, this silicate cement meets requirements for Grade 42.5 as specified in Chinese National Standard GB175-2020 Common portland cement. Thus, a comprehensive utilization of the iron separation tailings from magnetizing-roasted red mud was achieved.

### Example 5

Iron separation tailings from magnetizing-roasted red mud used in this example were iron separation tailings from magnetizing-roasted red mud obtained during alumina production using the Bayer process at an aluminum plant in Gui Zhou province of China. The iron separation tailings from magnetizing-roasted red mud, by weight percentage, contains 16.96% of Al₂O₃, 14.39% of SiO₂, 52.87% of Fe₂O₃, and 1.52% of CaO; and a content of fineness of-0.038 mm of the iron separation tailings from magnetizing-roasted red mud was 54.09%. In the iron separation tailings from magnetizing-roasted red mud in this example, valuable minerals were diaspore and gibbsite; and gangue minerals were mainly alumogoethite, hematite, calcite, and hydrogarnet, and the like. The comprehensive utilization method for the iron separation tailings from magnetizing-roasted red mud disclosed in this example includes the following steps.

First, the iron separation tailings from magnetizing-roasted red mud was subjected to a processing of wet magnetic separation for tailing discarding including one stage of roughing (during which a magnetic field intensity was 0.3 T; a pulsation frequency was 230 times/min) and two stages of scavenging (Scavenging 1: a magnetic field intensity was 0.5 T; a pulsation frequency was 240 times/min; Scavenging 2: a magnetic field intensity was 0.6 T; a pulsation frequency was 280 times/min), to obtain a rough concentrate and non-magnetic minerals. The rough concentrate was subjected to a processing of purification by gravity separation including one stage of roughing (using a centrifugal gravity separation process) and one stage of cleaning (using a spiral chute for gravity separation process). After the purification by gravity separation, a wet iron concentrate and light minerals were obtained. The non-magnetic minerals and the light minerals were combined to obtain wet tailings. The wet tailings were dehydrated, dried, and disintegrated to obtain iron extraction tailings. In this example, for the iron concentrate, a yield was 21.32%, a content of Fe₂O₃ was 81.01%, and the iron concentrate could be sold as a raw material for iron and steel; for the iron extraction tailings, a yield was 78.68%, a content of Fe₂O₃ was 45.240%, and a content of water was 1.53%, and a content of fineness of-0.074 mm was 93.77%. The cement clinker was preset with KH of 0.86, SM of 2.2, and IM of 1.1. Based on main chemical compositions of each raw material for preparing the cement raw meal, referring to Table 9, a calculated predetermined ratio for the cement raw meal was: 6.10% of iron extraction tailings, 73.56% of limestone, 16.27% of clay, and 4.07% of quartz sand separation tailings. Therefore, the cement raw meal can be prepared by uniformly mixing the iron extraction tailings, the limestone, the clay, and the quartz sand separation tailings according to the predetermined ratio. The cement raw meal was pressed under a pressure of 6 MPa into a cylinder with a diameter of 50 mm and a height of 40 mm. The cylinder formed by pressing the cement raw meal was calcined at 1450° C. for 80 min, then taken out and quenched to obtain a cement clinker. The cement clinker was mixed with a gypsum in a ratio of 88:12 and then dry-ground. A specific surface area of ground materials was controlled to be 400 m²/kg and a content of fineness of-0.045 mm was controlled to be 95%, to finally obtain a silicate cement.

The prepared silicate cement was taken. A setting time of the silicate cement was measured and determined according to the Chinese National Standard GB/T 1346-2011 Test methods for water requirement of normal consistency, setting time and soundness of the portland cement; a compressive strength and a flexural strength of the silicate cement were measured and determined according to the Chinese National Standard GB/T 17671-2021 Test method of cement mortar strength (ISO method), i.e., the silicate cement, a standard sand, and a water with a ratio of 450:1350:225 were made into a prism with dimensions of 40 mm×40 mm×160 mm. The prism was demolded after 1 day and cured. The compressive strength and the flexural strength of the prism at 3 days and 28 days were measured, respectively, to analyze a performance of the silicate cement. Test results of indicators of iron extraction and indicators of the silicate cement were shown in Table 10.

TABLE 9
Main chemical composition (%) of raw materials for cement preparation in Example 5

| Item | CaO | SiO₂ | Al₂O₃ | Fe₂O₃ | MgO | SO₃ | K₂O | Na₂O | Loss | Total |
|---|---|---|---|---|---|---|---|---|---|---|
| Limestone | 52.79 | 1.58 | 0.52 | 0.11 | 0.13 | 0.01 | 0 | 1.25 | 42.22 | 98.61 |
| Clay | 12.64 | 49.55 | 12.94 | 3.24 | 0.15 | 2.31 | 0.91 | 4.01 | 13.88 | 99.63 |
| Quartz sand | 0.11 | 90.45 | 0.12 | 0.27 | 0.13 | 0 | 0.22 | 0.24 | 5.74 | 97.28 |
| separation tailings | | | | | | | | | | |
| Iron extraction | 1.61 | 16.42 | 18.71 | 45.24 | 0.47 | 0.03 | 0.61 | 0.88 | 6.22 | 90.19 |
| tailings | | | | | | | | | | |

TABLE 10
Test results of indicators of iron extraction and
indicators of the silicate cement for Example 5

| | | | Test results of silicate cement | | | | | |
|---|---|---|---|---|---|---|---|---|
| | | | prepared from iron extraction tailings | | | | | |
| Test results of iron extraction/% | | | Setting time/min | | Compressive | | Flexural | |
| | | Content | Initial | Final | strength/MPa | | strength/MPa | |
| Name | Yield | of Fe₂O₃ | setting | setting | 3 d | 28 d | 3 d | 28 d |
| Iron concentrate | 21.32 | 81.01 | 60 | 135 | 27.8 | 60.8 | 4.6 | 8.9 |
| Iron extraction | 78.68 | 45.24 | | | | | | |
| tailings | | | | | | | | |
| Total | 100.00 | 52.87 | | | | | | |

As can be seen from the test results in Table 10, after the iron separation tailings from magnetizing-roasted red mud disclosed in this example were subjected to a processing of an iron extraction process of combined magnetic separation-gravity separation, an iron concentrate with a yield of 21.32% and a content of Fe₂O₃ of 81.01%, and iron extraction tailings with a yield of 78.68% and a content of Fe₂O₃ of 45.24% were obtained. The silicate cement prepared from the iron extraction tailings has the compressive strengths of 27.8 MPa and 60.8 MPa at 3 days and 28 days, respectively, and the flexural strengths of 4.6 MPa and 8.9 MPa at 3 days and 28 days, respectively. The initial setting time and the final setting time of the silicate cement were 60 min and 135 min, respectively. According to the comprehensive evaluation of indicators of the setting time, compressive strength, and flexural strength, this silicate cement meets requirements for Grade 52.5 as specified in Chinese National Standard GB175-2020 Common portland cement, and a comprehensive utilization of the iron separation tailings from magnetizing-roasted red mud was achieved.

### Comparative Example 1

Comparative Example 1 was compared with Example 1, and a difference between Comparative Example 1 and Example 1 was as follows.

Selected iron separation tailings from magnetizing-roasted red mud were the same as those in Example 1, and a method disclosed in the invention patent CN202111388163.8 was used, with raw red mud being replaced by the iron separation tailings from magnetizing-roasted red mud, to prepare a high-iron cement.

The prepared high-iron cement was tested according to the same test methods as in Example 1, to analyze a performance of the high-iron cement. From the tests, it can be seen that the high-iron cement has the compressive strengths at 3 days and 28 days of 17.2 MPa and 42.8 MPa, respectively, and the flexural strengths at 3 days and 28 days of 3.9 MPa and 7.1 MPa, respectively. The initial setting time and a final setting time of the high-iron cement were 78 min and 220 min, respectively. According to the comprehensive evaluation of indicators of the setting time, compressive strength, and flexural strength, this high-iron cement meets requirements for Grade 42.5 as specified in Chinese National Standard GB175-2020 Common portland cement, and a comprehensive utilization of the iron separation tailings from magnetizing-roasted red mud was achieved. Compared with the silicate cement (Grade 52.5) prepared in Example 1 in terms of compressive strength and flexural strength, the high-iron cement prepared in Comparative Example 1 has lower compressive strength and flexural strength than those of the silicate cement prepared in Example 1. Moreover, in Example 1, an iron concentrate, which has a yield of 12.41%, as content of Fe₂O₃ of 80.42% and a higher economic value, was obtained. Therefore, the embodiments of the disclosure were more suitable for comprehensive utilization of the iron separation tailings from magnetizing-roasted red mud compared to the method disclosed in the invention patent CN202111388163.8.

### Comparative Example 2

Comparative Example 2 was compared with Example 2, and a difference between Comparative Example 2 and Example 2 was as follows:

Selected iron separation tailings from magnetizing-roasted red mud were the same as those in Example 2, and a method disclosed in the invention patent CN202111388163.8 was used, with raw red mud being replaced by the iron separation tailings from magnetizing-roasted red mud, to prepare a high-iron cement.

The prepared high-iron cement was tested according to the same test methods as in Example 2, to analyze a performance of the high-iron cement. From the tests, it can be seen that the high-iron cement has the compressive strengths at 3 days and 28 days of 16.55 MPa and 38.4 MPa, respectively, and the flexural strengths at 3 days and 28 days of 3.2 MPa and 7.2 MPa, respectively. The initial setting time and the final setting time of the high-iron cement were 88 min and 245 min, respectively. According to the comprehensive evaluation of indicators of the setting time, compressive strength, and flexural strength, it can be seen that the compressive strength and flexural strength of this high-iron cement do not meet the minimum standard requirement for Grade 42.5 as specified in Chinese National Standard GB175-2020 Common portland cement, rendering the high-iron cement unmarketable. Compared with the silicate cement (Grade 52.5) prepared in Example 2 in terms of compressive strength and flexural strength, the high-iron cement prepared in Comparative Example 2 has lower compressive strength and flexural strength than those of the silicate cement prepared in Example 2. Moreover, in Example 2, an iron concentrate, which has a yield of 13.62%, a content of Fe₂O₃ of 81.85% and a higher economic value, was obtained. Therefore, the embodiments of the disclosure were more suitable for comprehensive utilization of the iron separation tailings from magnetizing-roasted red mud compared to the method disclosed in the invention patent CN202111388163.8.

### Comparative Example 3

Comparative Example 3 was compared with Example 3, and a difference between Comparative Example 3 and Example 3 was as follows:

Selected iron separation tailings from magnetizing-roasted red mud were the same as those in Example 3. The method disclosed in the invention patent CN202111388163.8 was used, with raw red mud being replaced by the iron separation tailings from magnetizing-roasted red mud, to prepare a high-iron cement.

The prepared high-iron cement was tested according to the same test methods as in Example 3, to analyze a performance of the high-iron cement. From the tests, it can be seen that the high-iron cement has the compressive strengths at 3 days and 28 days of 14.3 MPa and 33.2 MPa, respectively, and the flexural strengths at 3 days and 28 days of 1.8 MPa and 5.3 MPa, respectively. The initial setting time and the final setting time of the high-iron cement were 92 min and 290 min, respectively. According to the comprehensive evaluation of indicators of the setting time, compressive strength, and flexural strength, it can be seen that the compressive strength and flexural strength of this high-iron cement do not meet the minimum standard requirement for Grade 42.5 as specified in Chinese National Standard GB175-2020 Common portland cement, rendering the high-iron cement unmarketable. Compared with the silicate cement (Grade 52.5) prepared in Example 3 in terms of compressive strength and flexural strength, the high-iron cement prepared in Comparative Example 3 has lower compressive strength and flexural strength than those of the silicate cement prepared in Example 3. Moreover, in Example 3, an iron concentrate, which has a yield of 18.62%, a content of Fe₂O₃ of 81.33% and a higher economic value, was obtained. Therefore, the embodiments of the disclosure were more suitable for comprehensive utilization of the iron separation tailings from magnetizing-roasted red mud compared to the method disclosed in the invention patent CN202111388163.8

Indicators of compressive strength and flexural strength of the silicate cement prepared in Examples 1-5 and the high-iron cement prepared in Comparative Examples 1-3 were statistically analyzed, and results are shown in Table 11.

TABLE 11
Test Results of Examples and Comparative Examples

| | Setting time/min | | Compressive | | Flexural | |
|---|---|---|---|---|---|---|
| | Initial | Final | strength/MPa | | strength/MPa | |
| Case | setting | setting | 3 d | 28 d | 3 d | 28 d |
| Example 1 | 48 | 112 | 28.6 | 60.3 | 4.8 | 8.5 |
| Example 2 | 61 | 133 | 27.8 | 59.5 | 4.8 | 8.6 |
| Example 3 | 56 | 132 | 25.4 | 58.9 | 4.9 | 8.1 |
| Example 4 | 55 | 125 | 21.6 | 50.3 | 4.1 | 6.9 |
| Example 5 | 60 | 135 | 27.8 | 60.8 | 4.6 | 8.9 |
| Comparative | 78 | 220 | 17.2 | 42.8 | 3.9 | 7.1 |
| Example 1 | | | | | | |
| Comparative | 88 | 245 | 16.55 | 38.4 | 3.2 | 7.2 |
| Example 2 | | | | | | |
| Comparative | 92 | 290 | 14.3 | 33.2 | 1.8 | 5.3 |
| Example 3 | | | | | | |

As can be seen from the test results in Table 11, specifications of the silicate cement prepared from the iron extraction tailings in Examples 1-5 of the disclosure all meet or exceed requirements for Grade 42.5 for common portland cement, whereas specifications of the high-iron cement prepared in Comparative Examples 1-3 meet or were below requirements for Grade 42.5 for common portland cement. Furthermore, in Examples 1-5, iron concentrate with considerable yield and high-quality (content of Fe₂O₃>80%) was obtained, which can be sold as a raw material for iron and steel production, resulting in higher economic value. Therefore, Examples 1-5 of the disclosure possess significant advantages over Comparative Examples 1-3 and were more suitable for comprehensive utilization of the iron separation tailings from magnetizing-roasted red mud.

Compared with the related art, the comprehensive utilization method for the iron separation tailings from magnetizing-roasted red mud according to some embodiments of the disclosure has the following advantages:

According to the comprehensive utilization method for the iron separation tailings from magnetizing-roasted red mud in some embodiments of the disclosure, by ways such as magnetic separation and gravity separation, an iron concentrate can be extracted from the iron separation tailings from magnetizing-roasted red mud for iron and steel smelting; the obtained iron extraction tailings were mixed with limestone, clay, and quartz sand separation tailings and can be used to prepare silicate cement, and the silicate cement meets grade requirements of Chinese National Standard GB175-2020 Common portland cement. By processing the iron separation tailings from magnetizing-roasted red mud with the method of the disclosure, iron resources, silicon resources, and calcium resources therein can be fully utilized, thereby effectively achieving efficient utilization of the iron separation tailings from magnetizing-roasted red mud.

Various embodiments of the disclosure may be presented in the form of a range. It should be understood that a description in the form of a range is merely for convenience and brevity and should not be construed as a rigid limitation on the scope of the disclosure. Therefore, the description of the range should be considered as having specifically disclosed all possible sub-ranges as well as individual numerical values within that range. For example, a description of a range from 1 to 6 should be considered as having specifically disclosed sub-ranges, for example, from 1 to 3, from 1 to 4, from 1 to 5, from 2 to 4, from 2 to 6, from 3 to 6, and the like, as well as individual numbers within the stated range, for example, 1, 2, 3, 4, 5, and 6, this being applicable regardless of the breadth of the range. Furthermore, whenever a numerical range is indicated herein, it is meant to include any cited number (fraction or integer) within the recited range.

In the disclosure, in the absence of contrary explanation, the directional terms used such as “upper” and “lower” specifically refer to the directions in the drawings. Furthermore, in the description of the disclosure, the terms “comprise”, “include”, and the like., mean “including but not limited to”. Moreover, the terms “comprise”, “include”, or any other variants thereof are intended to cover non-exclusive inclusion, so that a process, method, article, or device that includes a series of elements not only includes those elements, but also includes other elements not explicitly listed, or elements inherent to such process, method, article, or device. Without more limitations, an element defined by the phrase “comprising . . . ” does not exclude the presence of additional identical elements in the process, method, article, or device that includes the said element. Herein, relational terms such as “first” and “second” are used only to distinguish one entity or operation from another entity or operation, and do not necessarily require or imply any actual such relationship or order between these entities or operations. Herein, “and/or” describes an association relationship between associated objects, indicating that three relationships may exist. For example, A and/or B may indicate: A existing alone, both A and B existing simultaneously, or B existing alone. For an association relationship involving three or more objects described by “and/or”, it indicates that any single one of these associated objects can exist alone, or any at least two of them can exist simultaneously. For example, for A, and/or B, and/or C, it may indicate: any single one of A, B, or C existing alone; any two of them existing simultaneously; or all three of them existing simultaneously. Herein, “at least one” means one or more, and “a plurality of” means two or more. “At least one of”, “at least one item of the following”, or similar expressions thereof, refer to any combination of these items, including any combination of single item(s) or plural item(s). For example, “at least one of a, b, or c”, or “at least one of a, b, and c”, can mean: a, b, c, a-b (i.e., a and b), a-c, b-c, or a-b-c, wherein a, b, c can be single or multiple respectively.

The foregoing descriptions are merely specific embodiments of the disclosure, provided to enable those skilled in the art to understand or implement the disclosure. Various modifications to these embodiments will be readily apparent to those skilled in the art, and the general principles defined herein may be implemented in other embodiments without departing from the spirit or scope of the disclosure. Therefore, the disclosure will not be limited to the embodiments shown herein but is to be accorded the widest scope consistent with the principles and novel features disclosed herein.

1. A comprehensive utilization method for iron separation tailings from magnetizing-roasted red mud, comprising:
performing a wet magnetic separation for tailing discarding on the iron separation tailings from magnetizing-roasted red mud, to obtain a rough concentrate and non-magnetic minerals;
performing a gravity separation and purification on the rough concentrate to obtain a wet iron concentrate and light minerals;
dehydrating the wet iron concentrate to obtain an iron concentrate;
combining the non-magnetic minerals and the light minerals, followed by a dehydration, drying, and disintegration, to obtain iron extraction tailings;
uniformly mixing the iron extraction tailings, and crushed, ground and dried limestone, clay, and quartz sand separation tailings according to a predetermined ratio, to obtain a cement raw meal;
pressing, and then calcining and quenching the cement raw meal, to obtain a cement clinker; and,
mixing the cement clinker and a gypsum, followed by a dry grinding, to obtain a silicate cement.

2. The comprehensive utilization method for the iron separation tailings from magnetizing-roasted red mud according to claim 1, wherein based on a mass percentage of the iron separation tailings from magnetizing-roasted red mud, in the iron separation tailings from magnetizing-roasted red mud, a content of Fe₂O₃ is not higher than 58%; a content of SiO₂ is not higher than 15%; a content of CaO is not higher than 2.5%; and a content of Na₂O is not higher than 1.0%.

3. The comprehensive utilization method for the iron separation tailings from magnetizing-roasted red mud according to claim 1, wherein in the iron separation tailings from magnetizing-roasted red mud, a proportion of particles with a particle size of less than 0.038 mm is 50% to 60%.

4. The comprehensive utilization method for the iron separation tailings from magnetizing-roasted red mud according to claim 1, wherein a magnetic field intensity of the wet magnetic separation for tailing discarding is 0.3 T to 0.6 T; and/or,
a pulsation frequency of the wet magnetic separation for tailing discarding is 220 times/min to 290 times/min.

5. The comprehensive utilization method for the iron separation tailings from magnetizing-roasted red mud according to claim 1, wherein the purification by gravity separation is at least two processes connected in series which are selected from the group consisting of a purification by gravity separation process using a shaking table, a centrifugal purification by gravity separation process, and a purification by gravity separation process using a spiral chute;
and/or, the number of times of the purification by gravity separation process is 2 to 3 times.

6. The comprehensive utilization method for the iron separation tailings from magnetizing-roasted red mud according to claim 1, wherein, in the iron extraction tailings, a proportion of particles with a particle size of less than 0.074 mm is more than 88%;
and/or, a content of water in the iron extraction tailings is not higher than 2%.

7. The comprehensive utilization method for the iron separation tailings from magnetizing-roasted red mud according to claim 1, wherein, based on a mass percentage of the cement raw meal, the predetermined ratio is: 4% to 12% of iron extraction tailings, 60% to 75% of limestone, 15% to 25% of clay, and 4% to 8% of quartz sand separation tailings.

8. The comprehensive utilization method for the iron separation tailings from magnetizing-roasted red mud according to claim 1, wherein in the step of pressing, and then calcining and quenching the cement raw meal to obtain the cement clinker, a pressure for the pressing ranges from 3 MPa to 6 MPa.

9. The comprehensive utilization method for the iron separation tailings from magnetizing-roasted red mud according to claim 1, wherein in the step of pressing and then calcining and quenching the cement raw meal to obtain the cement clinker, a temperature for the calcining ranges from 1350° C. to 1450° C., and a time for the calcining ranges from 70 min to 120 min.

10. The comprehensive utilization method for the iron separation tailings from magnetizing-roasted red mud according to claim 1, wherein a specific surface area of the silicate cement is 380 m²/kg˜400 m²/kg, wherein a proportion of particles with a particle size of less than 0.045 mm is 93% to 95%.
